(19) United States
(12) Patent Application Publication
(10) Pub. No.: US 2024/0242295 A1
(43) Pub. Date: Jul. 18, 2024

(54) TICKET PROCESSING

(71) Applicant: Alipay (Hangzhou) Information Technology Co., Ltd., Hangzhou (CN)

(72) Inventors: Junwei WANG, Hangzhou (CN); Min HUANG, Hangzhou (CN); Wenhu KAN, Hangzhou (CN); Xiaocai LIU, Hangzhou (CN); Wenfeng CHEN, Hangzhou (CN)

(21) Appl. No.: 18/563,603

(22) PCT Filed: Jul. 4, 2022
(86) PCT No.: PCT/CN2022/103546

§ 371 Date: Nov. 22, 2023

(30) Foreign Application Priority Data
May 25, 2021 (CN) 202110572091.6

(51) Int. Cl. G06Q 40/12; G06Q 40/10

(52) U.S. Cl. CPC G06Q 40/125; G06Q 40/10

(57) ABSTRACT

Embodiments of this specification provide a ticket processing method, apparatus, and device, and a storage medium. The method includes: obtaining a to-be-processed electronic ticket, order data, and bill data, where the bill data is generated after a payment is made for the order data by using a reimbursement code, and the electronic ticket is generated based on the bill data; creating an editable reimbursement form based on at least one of the electronic ticket, the order data, and the bill data; performing credibility verification on the editable reimbursement form in at least one verification dimension based on the electronic ticket, the order data, and the bill data; and if verification in each verification dimension succeeds, determining that the editable reimbursement form is a credible reimbursement form.

### TECHNICAL FIELD

This specification relates to the field of computer technologies, and in particular, to a ticket processing method, apparatus, and device, and a storage medium.

### BACKGROUND

In a business consumption reimbursement scenario, due to financial and tax requirements, an enterprise finance department needs to spend a great deal of energy verifying authenticity of tickets, for example, reviewing whether consumption corresponding to the tickets is real and whether consumption content, a consumption time, and a consumption amount match those recorded in the tickets. Currently, reimbursement is performed only based on tickets submitted by reimbursement persons, and therefore it is difficult to verify authenticity of the tickets, and false reimbursement is prone to occur.

### SUMMARY

An embodiment of this specification provides a ticket processing method. The ticket processing method includes: obtaining a to-be-processed electronic ticket, order data, and bill data, where the bill data is generated after a payment is made for the order data by using a reimbursement code, and the electronic ticket is generated based on the bill data; creating an editable reimbursement form based on at least one of the electronic ticket, the order data, and the bill data; performing credibility verification on the editable reimbursement form in at least one verification dimension based on the electronic ticket, the order data, and the bill data; and if verification in each verification dimension succeeds, determining that the editable reimbursement form is a credible reimbursement form.

Another embodiment of this specification provides a ticket processing apparatus, including: a data obtaining unit, configured to obtain a to-be-processed electronic ticket, order data, and bill data, where the bill data is generated after a payment is made for the order data by using a reimbursement code, and the electronic ticket is generated based on the bill data; a form creation unit, configured to create an editable reimbursement form based on at least one of the electronic ticket, the order data, and the bill data; a form verification unit, configured to perform credibility verification on the editable reimbursement form in at least one verification dimension based on the electronic ticket, the order data, and the bill data; and a result determining unit, configured to: if verification in each verification dimension succeeds, determine that the editable reimbursement form is a credible reimbursement form.

Another embodiment of this specification provides a ticket processing device, including a processor and a storage configured to store computer-executable instructions. When the computer-executable instructions are executed by the processor, the processor is enabled to implement the following operations: obtaining a to-be-processed electronic ticket, order data, and bill data, where the bill data is generated after a payment is made for the order data by using a reimbursement code, and the electronic ticket is generated based on the bill data; creating an editable reimbursement form based on at least one of the electronic ticket, the order data, and the bill data; performing credibility verification on the editable reimbursement form in at least one verification dimension based on the electronic ticket, the order data, and the bill data; and if verification in each verification dimension succeeds, determining that the editable reimbursement form is a credible reimbursement form.

Another embodiment of this specification provides a storage medium, configured to store computer-executable instructions. When the computer-executable instructions are executed by a processor, the processor is enabled to implement the following operations: obtaining a to-be-processed electronic ticket, order data, and bill data, where the bill data is generated after a payment is made for the order data by using a reimbursement code, and the electronic ticket is generated based on the bill data; creating an editable reimbursement form based on at least one of the electronic ticket, the order data, and the bill data; performing credibility verification on the editable reimbursement form in at least one verification dimension based on the electronic ticket, the order data, and the bill data; and if verification in each verification dimension succeeds, determining that the editable reimbursement form is a credible reimbursement form.

### BRIEF DESCRIPTION OF DRAWINGS

To describe the technical solutions in one or more embodiments of this specification more clearly, the following briefly describes the accompanying drawings needed for describing the embodiments. Clearly, the accompanying drawings in the following description merely show some embodiments of this specification, and a person of ordinary skill in the art can still derive other drawings from these accompanying drawings without creative efforts.

FIG. 1 is a schematic flowchart of a ticket processing method according to an embodiment of this specification;

FIG. 2 is a schematic flowchart of a ticket processing method according to another embodiment of this specification;

FIG. 3 is a schematic flowchart of a ticket processing method according to another embodiment of this specification;

FIG. 4 is a schematic diagram of a scenario of a ticket processing method according to an embodiment of this specification;

FIG. 5 is a schematic diagram of module composition of a ticket processing apparatus according to an embodiment of this specification; and

FIG. 6 is a schematic diagram of a structure of a ticket processing device according to an embodiment of this specification.

### DESCRIPTION OF EMBODIMENTS

To make a person skilled in the art understand the technical solutions in one or more embodiments of this specification better, the following clearly and comprehensively describes the technical solutions in the one or more embodiments of this specification with reference to the accompanying drawings in the one or more embodiments of this specification. Clearly, the described embodiments are merely some but not all of the embodiments of this specification. All other embodiments obtained by a person of ordinary skill in the art based on the one or more embodiments of this specification without creative efforts shall fall within the protection scope of this specification.

In consideration of a problem that currently, reimbursement is performed only based on tickets submitted by reimbursement persons, and therefore it is difficult to verify authenticity of the tickets, and false reimbursement is prone to occur, one or more embodiments of this specification provide a ticket processing method, to improve accuracy of reimbursement review and avoid false reimbursement. The ticket processing method provided in the one or more embodiments of this specification can be applied to a reimbursement system, and is performed by the reimbursement system.

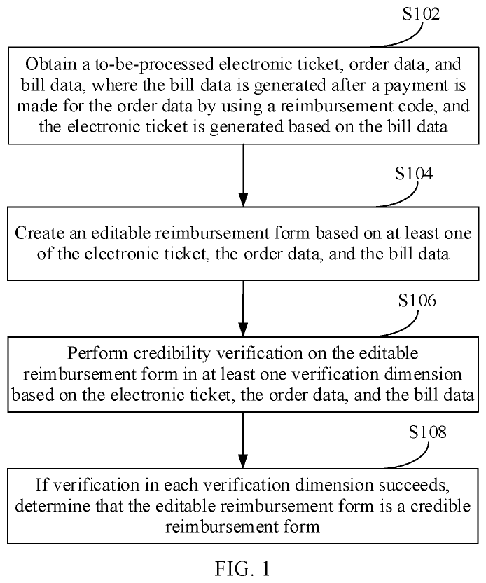

FIG. 1 is a schematic flowchart of a ticket processing method according to an embodiment of this specification. The method can be applied to a reimbursement system, and is performed by the reimbursement system. As shown in FIG. 1, the method includes the following steps S102 to S108.

Step S102: Obtain a to-be-processed electronic ticket, order data, and bill data, where the bill data is generated after a payment is made for the order data by using a reimbursement code, and the electronic ticket is generated based on the bill data.

Step S104: Create an editable reimbursement form based on at least one of the electronic ticket, the order data, and the bill data.

Step S106: Perform credibility verification on the editable reimbursement form in at least one verification dimension based on the electronic ticket, the order data, and the bill data.

Step S108: If verification in each verification dimension succeeds, determine that the editable reimbursement form is a credible reimbursement form.

In this embodiment, after the to-be-processed electronic ticket, the order data, and the bill data are obtained, the editable reimbursement form can be created, and credibility verification can be performed on the editable reimbursement form in the at least one verification dimension based on the electronic ticket, the order data, and the bill data, to improve accuracy of reimbursement review and avoid false reimbursement.

In step S102, the reimbursement system obtains the to-be-processed electronic ticket, the order data, and the bill data. This step has two implementations.

Manner 1: That the reimbursement system obtains a to-be-processed electronic ticket, order data, and bill data includes: (a1) obtaining a reimbursement identifier submitted by a user, where the reimbursement identifier includes any one of a ticket identifier, an order identifier, and a bill identifier; (a2) transferring the reimbursement identifier to a third-party voucher system; and (a3) receiving the electronic ticket, the order data, and the bill data that are returned by the third-party voucher system based on the reimbursement identifier.

In this embodiment, the third-party voucher system stores a plurality of pieces of order data, bill data associated with each piece of order data, and an electronic ticket associated with each piece of bill data. The electronic ticket can be an electronic invoice. Specifically, after the user generates an order by using a transaction system, the transaction system sends order data of the user to a payment system. After the user makes a payment for the order data through payment system, the payment system generates bill data associated with the order data, and the payment system further sends the order data and the bill data to a ticket issuance system. After a merchant generates, through the ticket issuance system, an electronic ticket associated with the bill data, the ticket issuance system transfers the order data, the bill data, and the electronic ticket to the third-party voucher system for storage. Therefore, the third-party voucher system stores a plurality of pieces of order data, bill data associated with each piece of order data, and an electronic ticket associated with each piece of bill data.

The reimbursement system obtains the reimbursement identifier submitted by the user. The reimbursement identifier includes any one of the ticket identifier, the order identifier, and the bill identifier. The reimbursement system transfers the reimbursement identifier to the third-party voucher system. The third-party voucher system searches, based on the reimbursement identifier, for the order data, the bill data, and the electronic ticket that are associated with each other, and sends the found order data, bill data, and electronic ticket to the reimbursement system. Therefore, the reimbursement system receives the electronic ticket, the order data, and the bill data that are returned by the third-party voucher system based on the reimbursement identifier.

In an example, the reimbursement system transfers the order identifier to the third-party voucher system, and the third-party voucher system searches for the order data based on the order identifier, searches for the bill data associated with the order data and the electronic ticket associated with the bill data, and sends the found order data, bill data, and electronic ticket to the reimbursement system. Therefore, the reimbursement system receives the electronic ticket, the order data, and the bill data that are returned by the third-party voucher system based on the reimbursement identifier.

Manner 2: That the reimbursement system obtains a to-be-processed electronic ticket, order data, and bill data includes: (b1) obtaining a reimbursement identifier submitted by a user, where the reimbursement identifier includes any one of a ticket identifier, an order identifier, and a bill identifier; and (b2) searching a third-party voucher system for the electronic ticket, the order data, and the bill data based on the reimbursement identifier.

This manner is the same as the manner 1 in that the third-party voucher system stores a plurality of pieces of order data, bill data associated with each piece of order data, and an electronic ticket associated with each piece of bill data. A difference is as follows: After obtaining the reimbursement identifier submitted by the user, the reimbursement system actively searches, based on the reimbursement identifier, the third-party voucher system for the electronic ticket, the order data, and the bill data that are associated with each other.

In an example, the reimbursement system obtains the order identifier submitted by the user, searches the third-party system for the order data based on the order identifier, and searches for the bill data associated with the order data and the electronic ticket associated with the bill data, to find the order data, the bill data, and the electronic ticket.

It can be learned from the above-mentioned descriptions of the manner 1 and the manner 2 that in this embodiment, there is an association relationship between the electronic ticket, the order data, and the bill data obtained in step S102, the bill data is generated based on a payment action performed by the user on the order data, and the electronic ticket is obtained by issuing a ticket for the bill data. In a specific embodiment, the bill data is generated based on a payment action performed by the user on the order data by using the reimbursement code. The reimbursement code is a payment voucher established for the user by an institution such as a company or an enterprise and public institution in which the user is located. After a payment is made by using the reimbursement code, deduction can be directly performed in an account of the institution instead of in a personal account of the user, so that when the user is in a business consumption scenario, a payment can be directly made by the institution, and the user does not need to make an advance payment.

There is a case in which a combined payment is made for a plurality of orders. Therefore, in a case, in step S102, there are a plurality of pieces of order data and one piece of bill data, and the bill data is generated after the user makes a combined payment for all the pieces of order data by using the reimbursement code provided by the institution.

There is a case in which a payment is made only for some order content in an order. Therefore, in another case, in step S102, there is one piece of order data and one piece of bill data, and the bill data is generated after the user makes a payment for some order content in the order data by using the reimbursement code provided by the institution.

Combined ticket issuance can be performed for a plurality of bills. Therefore, in a case, in step S102, there is one electronic ticket and a plurality of pieces of bill data, and the electronic ticket is generated based on a combination of all the pieces of bill data.

A ticket can be issued for some content in a bill. Therefore, in another case, in step S102, there is one electronic ticket and one piece of bill data, and the electronic ticket is generated based on some bill content in the bill data.

The method in this embodiment can be applied to a plurality of scenarios such as combined payment, combined ticket issuance, partial payment, and partial ticket issuance. This is not specifically limited here.

In a specific embodiment, after the user logs in to the reimbursement system and enters a personal reimbursement interface, the user can transfer a ticket identifier of an unreimbursed electronic ticket to the reimbursement system. The reimbursement system obtains, in the manner 1 or the manner 2 based on the ticket identifier that is of the unreimbursed electronic ticket and that is transferred by the user, the unreimbursed electronic ticket of the user, bill data associated with the unreimbursed electronic ticket, and order data associated with the unreimbursed electronic ticket, and displays the obtained electronic ticket, order data, and bill data to the user, to implement step S102.

In step S104, that the reimbursement system creates an editable reimbursement form based on at least one of the electronic ticket, the order data, and the bill data specifically includes the following two manners.

Manner 1: That the reimbursement system creates an editable reimbursement form based on at least one of the electronic ticket, the order data, and the bill data includes: (c1) determining at least one type of target data selected by a user from the electronic ticket, the order data, and the bill data; and (c2) if data content of the target data meets a preset data content requirement corresponding to a reimbursement form, extracting a keyword from the target data, and creating an editable reimbursement form based on the extracted keyword.

The user can select, as the target data, at least one type of data from the electronic ticket, the order data, and the bill data displayed in the reimbursement system. The reimbursement system determines, based on a selection operation performed by the user, the at least one type of target data selected by the user from the electronic ticket, the order data, and the bill data. The reimbursement system determines whether the data content of the target data meets the preset data content requirement corresponding to the reimbursement form, for example, determines whether the data content of the target data includes all content included in the reimbursement form, or determines whether all content included in the reimbursement form can be generated based on the data content of the target data. All the content included in the reimbursement form includes content such as a consumption time, a reimbursement amount, and a reimbursement expense category.

If the reimbursement system determines that the data content of the target data meets the preset data content requirement corresponding to the reimbursement form, the reimbursement system extracts a keyword from the target data, and generates all the content included in the reimbursement form based on the extracted keyword, to create an editable reimbursement form. The extracted keyword includes content such as a consumption time, an amount that is spent, and a category of a purchased product.

If the data content of the target data does not meet the preset data content requirement corresponding to the reimbursement form, the reimbursement system can further select supplementary data from data other than the target data in the electronic ticket, the order data, and the bill data; and extract a keyword from the target data and the supplementary data, and create an editable reimbursement form based on the extracted keyword.

If the reimbursement system determines that the data content of the target data does not meet the preset data content requirement corresponding to the reimbursement form, the reimbursement system compares a content difference between the data content of the target data and the content included in the reimbursement form, and selects the supplementary data from the data other than the target data in the electronic ticket, the order data, and the bill data based on the content difference. Content of the supplementary data can supplement the content difference. Then, the reimbursement system extracts a keyword from the target data and the supplementary data, and creates an editable reimbursement form based on the extracted keyword. The extracted keyword includes content such as a consumption time, an amount that is spent, and a category of a purchased product.

Manner 2: That the reimbursement system creates an editable reimbursement form based on at least one of the electronic ticket, the order data, and the bill data includes: (d1) determining at least one type of target data selected by a user from the electronic ticket, the order data, and the bill data; (d2) extracting a keyword from the target data, and writing the extracted keyword into a preset reimbursement form template; and (d3) if there is no default item in the reimbursement form template into which the keyword is written, creating an editable reimbursement form based on the reimbursement form template into which the keyword is written.

The user can select, as the target data, at least one type of data from the electronic ticket, the order data, and the bill data displayed in the reimbursement system. The reimbursement system determines, based on a selection operation performed by the user, the at least one type of target data selected by the user from the electronic ticket, the order data, and the bill data. The reimbursement system extracts a keyword from the target data, and writes the extracted keyword into the preset reimbursement form template, for example, extracts a time keyword, and writes the time into a time bar in the preset reimbursement form template. When the keyword is written, the reimbursement system first determines whether the extracted keyword belongs to content to be written into the reimbursement form module. If yes, the keyword is written. If no, the keyword is not written. After extracting the keyword, the reimbursement system determines whether there is a default item in the reimbursement form template into which the keyword is written, and if no, creates an editable reimbursement form based on the reimbursement form template into which the keyword is written, for example, uses the reimbursement form template into which the keyword is written as the editable reimbursement form.

If there is a default item in the reimbursement form template into which the keyword is written, the reimbursement system selects supplementary data from data other than the target data in the electronic ticket, the order data, and the bill data based on the default item, extracts a keyword from the supplementary data, and writes the extracted keyword into the default item, to create an editable reimbursement form.

The reimbursement system can select the supplementary data from the data other than the target data in the electronic ticket, the order data, and the bill data based on content of the default item. Content of the supplementary data can supplement the default item. Then, the reimbursement system extracts a keyword from the supplementary data, writes the extracted keyword into the default item, and uses the reimbursement form template into which the keyword is written and in which there is no default item as the created editable reimbursement form.

It can be learned from the above-mentioned two manners that content of the editable reimbursement form comes from at least one of the order data, the bill data, and the electronic ticket, and comes from at least the target data selected by the user. When the data content of the target data is insufficient to generate the editable reimbursement form, the reimbursement system can further automatically select the supplementary data to generate the editable reimbursement form.

It should be emphasized here that in this embodiment, the content of the editable reimbursement form comes from at least one of the order data, the bill data, and the electronic ticket. Based on this, the reimbursement system can generate a reimbursement form identifier for the editable reimbursement form, establish an association relationship among the reimbursement form identifier, an order identifier of the order data, a bill identifier of the bill data, and a ticket identifier of the electronic ticket, and store the editable reimbursement form, the order data, the bill data, and the electronic ticket locally or in a third-party voucher system based on the association relationship, to obtain a four-in-one data model. Credibility review can be performed on the editable reimbursement form by using the model (as described in subsequent step S106). When performing expense reimbursement, an enterprise finance department needs to perform reimbursement based on a tax requirement and an electronic invoice, and the enterprise finance department can further obtain the order data and the bill data as a data record.

After generating the editable reimbursement form, the reimbursement system can provide the editable reimbursement form to a user for editing by the user. For example, the editable reimbursement form is displayed on a screen for editing by the user. In a process of editing the editable reimbursement form, the user can edit content such as a consumption time, a reimbursement amount, and a reimbursement expense category in the editable reimbursement form.

Correspondingly, in step S106, that the reimbursement system performs credibility verification on the editable reimbursement form in at least one verification dimension based on the electronic ticket, the order data, and the bill data can be: after the user edits the editable reimbursement form, obtaining an editable reimbursement form obtained through editing by the user; and performing, in at least one verification dimension based on the electronic ticket, the order data, and the bill data, credibility verification on the editable reimbursement form obtained through editing.

In an embodiment, after the editable reimbursement form is created in step S104, the reimbursement system can further check whether there is a reimbursement content item that does not conform to a preset reimbursement rule in the editable reimbursement form; and if yes, send corresponding prompt information to a user, to prompt the user to adjust content of the reimbursement content item. The preset reimbursement rule includes a preset time range, a preset amount range, a preset category range, and the like. The reimbursement content item includes a consumption time, a reimbursement amount, a reimbursement category, and the like. It can be checked whether the consumption time in the editable reimbursement form falls within the preset time range, whether the reimbursement amount falls within the preset amount range, and whether the reimbursement category falls within the preset category range, to determine whether there is a reimbursement content item that does not conform to the preset reimbursement rule. If it is determined, through check, that there is a reimbursement content item that does not conform to the preset reimbursement rule, the reimbursement system can send the corresponding prompt information to the user, to indicate the user to adjust the content of the reimbursement content item that does not conform to the preset reimbursement rule, for example, modify the consumption time, the reimbursement amount, and the reimbursement category.

Correspondingly, in step S106, the performing credibility verification on the editable reimbursement form in at least one verification dimension based on the electronic ticket, the order data, and the bill data is specifically: performing, in at least one verification dimension based on the electronic ticket, the order data, and the bill data, credibility verification on an editable reimbursement form fed back by the user based on the prompt information. Certainly, if it is determined, through check, that there is no reimbursement content item that does not conform to the preset reimbursement rule, step S106 is directly performed.

In an embodiment, in step S106, that the reimbursement system performs credibility verification on the editable reimbursement form in at least one verification dimension based on the electronic ticket, the order data, and the bill data can be: (e1) determining whether element information of the editable reimbursement form, the electronic ticket, the order data, and the bill data in the verification dimension pairwise matches; and (e2) if yes, determining that the credibility verification on the editable reimbursement form in the verification dimension succeeds.

In this embodiment, the verification dimension includes at least one dimension, and the verification dimension can include at least one of the following: a consumption time, a consumption amount, a commodity category, a commodity quantity, and a commodity name. The element information refers to a specific value in the verification dimension. For each verification dimension, the above-mentioned actions (e1) and (e2) are performed, and it is determined whether the credibility verification on the editable reimbursement form in the verification dimension succeeds.

Any verification dimension is used as an example. In the action (e1), it is determined whether the element information of the editable reimbursement form, the electronic ticket, the order data, and the bill data in the verification dimension pairwise matches. For example, it is determined whether amounts recorded in the editable reimbursement form, the electronic ticket, the order data, and the bill data pairwise match. A matching rule can be predefined. For example, it is defined as follows: The reimbursement amount in the editable reimbursement form needs to be less than or equal to the consumption amount in the electronic ticket, less than or equal to the consumption amount in the order data, and less than or equal to the consumption amount in the bill data, the consumption amount in the electronic ticket needs to be less than or equal to the consumption amount in the order data, and less than or equal to the consumption amount in the bill data, and the consumption amount in the order data needs to be greater than or equal to the consumption amount in the bill data. For another example, it is determined whether consumption times recorded in the editable reimbursement form, the electronic ticket, the order data, and the bill data are consistent. If the element information of the editable reimbursement form, the electronic ticket, the order data, and the bill data in the verification dimension pairwise matches, it is determined that the credibility verification on the editable reimbursement form in the verification dimension succeeds. Otherwise, it is determined that the credibility verification on the editable reimbursement form in the verification dimension fails.

In step S108, if the verification on the editable reimbursement form in each verification dimension succeeds, it is determined that the editable reimbursement form is a credible reimbursement form.

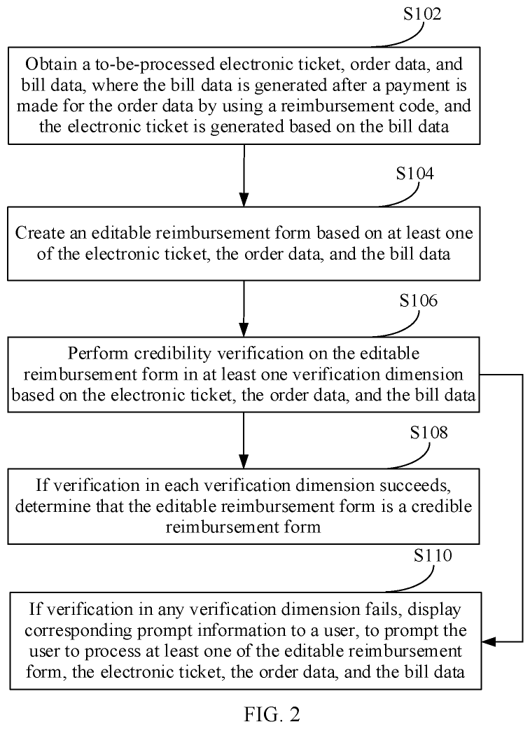

FIG. 2 is a schematic flowchart of a ticket processing method according to another embodiment of this specification. As shown in FIG. 2, on the basis of FIG. 1, the method further includes step S110: If verification in any verification dimension fails, display corresponding prompt information to a user, to prompt the user to process at least one of the editable reimbursement form, the electronic ticket, the order data, and the bill data.

For example, if verification in a verification dimension of consumption amount fails, corresponding prompt information is displayed to the user, and the user can modify the reimbursement amount in the editable reimbursement form based on the prompt information, or upload at least one of the electronic ticket, the order data, and the bill data again, to avoid a false reimbursement behavior of faking the reimbursement form by the user.

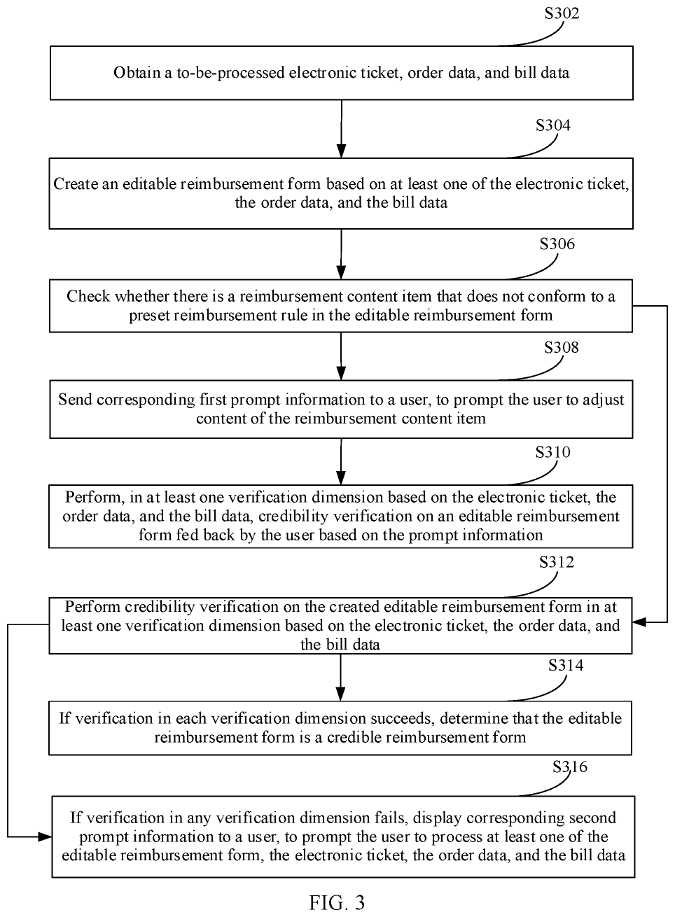

FIG. 3 is a schematic flowchart of a ticket processing method according to another embodiment of this specification. As shown in FIG. 3, the method is performed by a reimbursement system, and includes the following steps S302 to S316.

Step S302: Obtain a to-be-processed electronic ticket, order data, and bill data, where the bill data is generated after a payment is made for the order data by using a reimbursement code, and the electronic ticket is generated based on the bill data.

Step S304: Create an editable reimbursement form based on at least one of the electronic ticket, the order data, and the bill data.

Step S306: Check whether there is a reimbursement content item that does not conform to a preset reimbursement rule in the editable reimbursement form. If yes, step S308 is performed. If no, step S312 is performed.

Step S308: Send corresponding first prompt information to a user, to prompt the user to adjust content of the reimbursement content item.

Step S310: Perform, in at least one verification dimension based on the electronic ticket, the order data, and the bill data, credibility verification on an editable reimbursement form fed back by the user based on the prompt information.

Step S312: Perform credibility verification on the created editable reimbursement form in at least one verification dimension based on the electronic ticket, the order data, and the bill data.

Step S314: If verification in each verification dimension succeeds, determine that the editable reimbursement form is a credible reimbursement form.

Step S316: If verification in any verification dimension fails, display corresponding second prompt information to a user, to prompt the user to process at least one of the editable reimbursement form, the electronic ticket, the order data, and the bill data.

For the steps in FIG. 3, references can be made to the above-mentioned descriptions. No repeated descriptions are provided here.

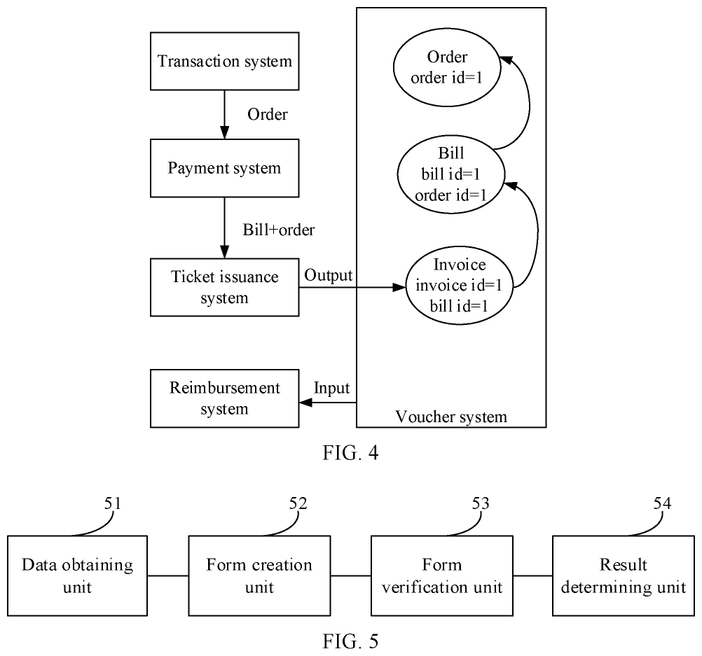

FIG. 4 is a schematic diagram of a scenario of a ticket processing method according to an embodiment of this specification. As shown in FIG. 4, the scenario includes a transaction system, a payment system, a ticket issuance system, and a reimbursement system.

If a user such as an institution employee completes order placement and generates an order through the transaction system, and an order identifier is, for example, order id=1, the transaction system synchronizes order information (order id=1 and other order information) to the payment system. The user completes a payment and generates a bill (a bill identifier is bill id=1 and an associated order identifier is order id=1) through the payment system, and records order-related information. The user initiates a ticket issuance application based on the bill (bill id=1). The ticket issuance system obtains the bill and an order completion invoice from the payment system (an invoice identifier is invoice id=1, and the associated bill is bill id=1), and outputs order (order id=1), bill (bill id=1 and order id=1), and invoice (invoice id=1 and bill id=1) data to a voucher system, to construct a three-in-one data voucher model centered around the invoice and based on the bill and the order, so that the associated bill can be found by using the invoice and the associated order can be found by using the bill.

The user sends a reimbursement identifier through the reimbursement system. The reimbursement system obtains the invoice and the associated bill and order data for display from the voucher system based on the reimbursement identifier. The user selects the invoice data to generate a reimbursement form. The reimbursement system performs credibility verification on the reimbursement form in at least one verification dimension based on the invoice, the order data, and the bill data. If verification in each verification dimension succeeds, it is determined that the reimbursement form is a credible reimbursement form. The reimbursement system submits the credible reimbursement form to a financial person for reimbursement processing.

In conclusion, according to the ticket processing method in this embodiment, a three-in-one relationship between an electronic ticket, order data, and bill data can be established, to implement mutual support between an order, a bill, and the ticket, meet a requirement for authenticity verification of enterprise reimbursement, and identify a problem that a ticket is issued after consumption, an actual consumption time does not fall within a business travel period but a ticket issuance time falls within the business travel period, there is actually no consumption but reimbursement is performed by using another invoice in a business travel period, an actual consumption amount is less than an amount in an issued ticket, or an enterprise employee consumes but a purchased commodity or service does not conform to a rule of an enterprise finance department.

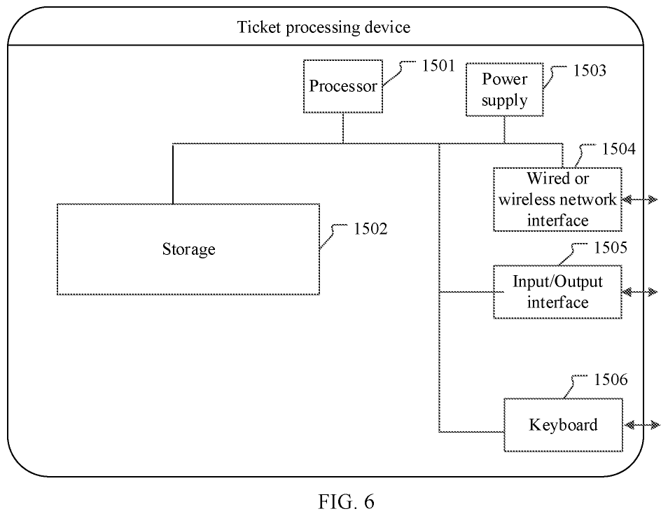

Based on the above-mentioned ticket processing method, this specification further provides a ticket processing apparatus. FIG. 5 is a schematic diagram of module composition of a ticket processing apparatus according to an embodiment of this specification. As shown in FIG. 5, the apparatus includes: a data obtaining unit 51, configured to obtain a to-be-processed electronic ticket, order data, and bill data, where the bill data is generated after a payment is made for the order data by using a reimbursement code, and the electronic ticket is generated based on the bill data; a form creation unit 52, configured to create an editable reimbursement form based on at least one of the electronic ticket, the order data, and the bill data; a form verification unit 53, configured to perform credibility verification on the editable reimbursement form in at least one verification dimension based on the electronic ticket, the order data, and the bill data; and a result determining unit 54, configured to: if verification in each verification dimension succeeds, determine that the editable reimbursement form is a credible reimbursement form.

Optionally, the data obtaining unit 51 obtains a reimbursement identifier submitted by a user, where the reimbursement identifier includes any one of a ticket identifier, an order identifier, and a bill identifier; transfers the reimbursement identifier to a third-party voucher system; and receives the electronic ticket, the order data, and the bill data that are returned by the third-party voucher system based on the reimbursement identifier.

Optionally, the data obtaining unit 51 obtains a reimbursement identifier submitted by a user, where the reimbursement identifier includes any one of a ticket identifier, an order identifier, and a bill identifier; and searches a third-party voucher system for the electronic ticket, the order data, and the bill data based on the reimbursement identifier.

Optionally, the form creation unit 52 determines at least one type of target data selected by a user from the electronic ticket, the order data, and the bill data; and if data content of the target data meets a preset data content requirement corresponding to a reimbursement form, extracts a keyword from the target data, and creates an editable reimbursement form based on the extracted keyword.

Optionally, the form creation unit 52 selects supplementary data from data other than the target data in the electronic ticket, the order data, and the bill data if the data content of the target data does not meet the preset data content requirement corresponding to the reimbursement form; and extracts a keyword from the target data and the supplementary data, and creates an editable reimbursement form based on the extracted keyword.

Optionally, the form creation unit 52 determines at least one type of target data selected by a user from the electronic ticket, the order data, and the bill data; extracts a keyword from the target data, and writes the extracted keyword into a preset reimbursement form template; and if there is no default item in the reimbursement form template into which the keyword is written, creates an editable reimbursement form based on the reimbursement form template into which the keyword is written.

Optionally, the form creation unit 52 selects supplementary data from data other than the target data in the electronic ticket, the order data, and the bill data based on the default item if there is a default item in the reimbursement form template into which the keyword is written; and extracts a keyword from the supplementary data, and writes the extracted keyword into the default item, to create an editable reimbursement form.

Optionally, the apparatus further includes an editing unit, configured to: after the editable reimbursement form is generated, provide the editable reimbursement form to a user for editing by the user.

Optionally, the form verification unit 53 obtains, after the user edits the editable reimbursement form, an editable reimbursement form obtained through editing by the user; and performs, in at least one verification dimension based on the electronic ticket, the order data, and the bill data, credibility verification on the editable reimbursement form obtained through editing.

Optionally, the form verification unit 53 determines whether element information of the editable reimbursement form, the electronic ticket, the order data, and the bill data in the verification dimension pairwise matches; and if yes, determines that the credibility verification on the editable reimbursement form in the verification dimension succeeds.

In this embodiment, after the to-be-processed electronic ticket, the order data, and the bill data are obtained, the editable reimbursement form can be created, and credibility verification can be performed on the editable reimbursement form in the at least one verification dimension based on the electronic ticket, the order data, and the bill data, to improve accuracy of reimbursement review and avoid false reimbursement.

The ticket processing apparatus in this embodiment of the specification can implement all processes in the above-mentioned ticket processing method, and have a same effect and function. No repeated descriptions are provided here.

Based on the above-mentioned ticket processing method, this specification further provides a ticket processing device. FIG. 6 is a schematic diagram of a structure of a ticket processing device according to an embodiment of this specification. As shown in FIG. 6, the ticket processing device can vary greatly based on configuration or performance, and can include one or more processors 1501 and a storage 1502. The storage 1502 can store one or more applications or data. The storage 1502 can be a temporary storage or a persistent storage. The application stored in the storage 1502 can include one or more modules (not shown in the figure), and each module can include a series of computer-executable instructions in the ticket processing device. Further, the processor 1501 can be configured to communicate with the storage 1502, and execute a series of computer-executable instructions in the storage 1502 on the ticket processing device. The ticket processing device can further include one or more power supplies 1503, one or more wired or wireless network interfaces 1504, one or more input/output interfaces 1505, one or more keyboards 1506, and the like.

In a specific embodiment, the ticket processing device is located in the above-mentioned reimbursement system, and the ticket processing device includes a processor and a storage configured to store computer-executable instructions. When the computer-executable instructions are executed by the processor, the processor is enabled to implement the following operations: obtaining a to-be-processed electronic ticket, order data, and bill data, where the bill data is generated after a payment is made for the order data by using a reimbursement code, and the electronic ticket is generated based on the bill data; creating an editable reimbursement form based on at least one of the electronic ticket, the order data, and the bill data; performing credibility verification on the editable reimbursement form in at least one verification dimension based on the electronic ticket, the order data, and the bill data; and if verification in each verification dimension succeeds, determining that the editable reimbursement form is a credible reimbursement form.

In this embodiment, after the to-be-processed electronic ticket, the order data, and the bill data are obtained, the editable reimbursement form can be created, and credibility verification can be performed on the editable reimbursement form in the at least one verification dimension based on the electronic ticket, the order data, and the bill data, to improve accuracy of reimbursement review and avoid false reimbursement.

The ticket processing device in this embodiment of the specification can implement all processes in the above-mentioned ticket processing method, and have a same effect and function. No repeated descriptions are provided here.

Another embodiment of this specification further provides a storage medium, configured to store computer-executable instructions. The storage medium can be a USB flash drive, an optical disc, a hard disk, or the like. When the computer-executable instructions stored in the storage medium are executed by a processor, the processor is enabled to implement the following procedure: obtaining a to-be-processed electronic ticket, order data, and bill data, where the bill data is generated after a payment is made for the order data by using a reimbursement code, and the electronic ticket is generated based on the bill data; creating an editable reimbursement form based on at least one of the electronic ticket, the order data, and the bill data; performing credibility verification on the editable reimbursement form in at least one verification dimension based on the electronic ticket, the order data, and the bill data; and if verification in each verification dimension succeeds, determining that the editable reimbursement form is a credible reimbursement form.

In this embodiment, after the to-be-processed electronic ticket, the order data, and the bill data are obtained, the editable reimbursement form can be created, and credibility verification can be performed on the editable reimbursement form in the at least one verification dimension based on the electronic ticket, the order data, and the bill data, to improve accuracy of reimbursement review and avoid false reimbursement.

The storage medium in this embodiment of the specification can implement all processes in the above-mentioned ticket processing method, and have a same effect and function. No repeated descriptions are provided here.

Specific embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular order or consecutive order to achieve the desired results. In some implementations, multi-tasking and parallel processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The storage controller can also be implemented as a part of the control logic of the storage. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, and the like. Therefore, the controller can be considered as a hardware component, and an apparatus that is configured to implement various functions and that is included in the controller can also be considered as a structure in the hardware component. Alternatively, an apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when one or more embodiments of this specification are implemented, functions of the units can be implemented in one or more pieces of software and/or hardware.

A person skilled in the art should understand that the embodiments of this specification can be provided as methods, systems, or computer program products. Therefore, the embodiments of this specification can use a form of hardware only embodiments, software only embodiments, or embodiments with a combination of software and hardware. In addition, the embodiments of this specification can use a form of a computer program product that is implemented on one or more computer-usable storage media (including but not limited to a disk storage, a CD-ROM, an optical storage, or the like) that include computer-usable program code.

The embodiments of this specification are described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more storages.

The storage can include a non-persistent memory, a random access memory (RAM), a nonvolatile memory, and/or another form in a computer-readable medium, for example, a read-only memory (ROM) or a flash memory (flash RAM). The storage is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. As described in this specification, the computer-readable medium does not include computer-readable transitory media such as a modulated data signal and a carrier. It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the embodiments of this specification can be provided as methods, systems, or computer program products. Therefore, the embodiments of this specification can use a form of hardware only embodiments, software only embodiments, or embodiments with a combination of software and hardware. In addition, the embodiments of this specification can use a form of a computer program product that is implemented on one or more computer-usable storage media (including but not limited to a disk storage, a CD-ROM, an optical storage, or the like) that include computer-usable program code.

One or more embodiments of this specification can be described in the general context of computer-executable instructions, for example, a program module. Generally, the program module includes a routine, a program, an object, a component, a data structure, and the like for executing a specific task or implementing a specific abstract data type. Alternatively, one or more embodiments of this specification can be practiced in distributed computing environments. In the distributed computing environments, tasks are performed by remote processing devices connected through a communication network. In the distributed computing environments, the program module can be located in a local and remote computer storage medium including a storage device.

The embodiments of this specification are described in a progressive manner. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this specification. A person skilled in the art can make various changes and variations to the embodiments of this specification. Any modification, equivalent replacement, or improvement made without departing from the spirit and principle of this specification shall fall within the scope of the claims of this specification.

1. A ticket processing method, comprising:
obtaining a to-be-processed electronic ticket, order data, and bill data, wherein the bill data is generated after a payment is made for the order data by using a reimbursement code, and the electronic ticket is generated based on the bill data;
creating an editable reimbursement form based on at least one of the electronic ticket, the order data, and the bill data;
performing credibility verification on the editable reimbursement form in at least one verification dimension based on the electronic ticket, the order data, and the bill data; and
upon determining that verification in each verification dimension succeeds, determining that the editable reimbursement form is a credible reimbursement form.

2. The method according to claim 1, wherein the obtaining a to-be-processed electronic ticket, order data, and bill data comprises:
obtaining a reimbursement identifier submitted by a user, wherein the reimbursement identifier comprises any one of a ticket identifier, an order identifier, and a bill identifier;
transferring the reimbursement identifier to a third-party voucher system; and
receiving the electronic ticket, the order data, and the bill data that are returned by the third-party voucher system based on the reimbursement identifier.

3. The method according to claim 1, wherein the obtaining a to-be-processed electronic ticket, order data, and bill data comprises:
obtaining a reimbursement identifier submitted by a user, wherein the reimbursement identifier comprises any one of a ticket identifier, an order identifier, and a bill identifier; and
searching a third-party voucher system for the electronic ticket, the order data, and the bill data based on the reimbursement identifier.

4. The method according to claim 2, wherein
for the electronic ticket and the bill data, the electronic ticket is generated based on a combination of all pieces of bill data, or the electronic ticket is generated based on some bill content in the bill data; and
for the bill data and the order data, the bill data is generated after the user makes a combined payment for all pieces of order data by using the reimbursement code provided by an institution, or the bill data is generated after the user makes a payment for some order content in the order data by using the reimbursement code provided by an institution.

5. The method according to claim 1, wherein the creating an editable reimbursement form based on at least one of the electronic ticket, the order data, and the bill data comprises:
determining at least one type of target data selected by a user from the electronic ticket, the order data, and the bill data; and
upon determining that data content of the target data meets a preset data content requirement corresponding to a reimbursement form, extracting a keyword from the target data, and creating an editable reimbursement form based on the extracted keyword.

6. The method according to claim 5, further comprising:
upon determining that the data content of the target data does not meet the preset data content requirement corresponding to the reimbursement form, selecting supplementary data from data other than the target data in the electronic ticket, the order data, and the bill data; and
extracting a keyword from the target data and the supplementary data, and creating an editable reimbursement form based on the extracted keyword.

7. The method according to claim 1, wherein the creating an editable reimbursement form based on at least one of the electronic ticket, the order data, and the bill data comprises:
determining at least one type of target data selected by a user from the electronic ticket, the order data, and the bill data;
extracting a keyword from the target data, and writing the extracted keyword into a preset reimbursement form template; and
upon determining that there is no default item in the reimbursement form template into which the keyword is written, creating an editable reimbursement form based on the reimbursement form template into which the keyword is written.

8. The method according to claim 7, further comprising:
upon determining that there is a default item in the reimbursement form template into which the keyword is written, selecting supplementary data from data other than the target data in the electronic ticket, the order data, and the bill data based on the default item; and
extracting a keyword from the supplementary data, and writing the extracted keyword into the default item, to create an editable reimbursement form.

9. The method according to claim 1, further comprising:
after generating the editable reimbursement form, providing the editable reimbursement form to a user for editing by the user.

10. The method according to claim 9, wherein the performing credibility verification on the editable reimbursement form in at least one verification dimension based on the electronic ticket, the order data, and the bill data comprises:
obtaining, after the user edits the editable reimbursement form, an editable reimbursement form obtained through editing by the user; and
performing, in at least one verification dimension based on the electronic ticket, the order data, and the bill data, credibility verification on the editable reimbursement form obtained through editing.

11. The method according to claim 1, wherein the performing credibility verification on the editable reimbursement form in at least one verification dimension based on the electronic ticket, the order data, and the bill data comprises:
determining whether element information of the editable reimbursement form, the electronic ticket, the order data, and the bill data in the verification dimension pairwise matches; and
upon determining that element information of the editable reimbursement form, the electronic ticket, the order data, and the bill data in the verification dimension pairwise matches, determining that the credibility verification on the editable reimbursement form in the verification dimension succeeds.

12. The method according to claim 11, wherein the verification dimension comprises at least one of the following: a consumption time, a consumption amount, a commodity category, a commodity quantity, and a commodity name.

13. The method according to claim 1, wherein after the creating an editable reimbursement form, the method further comprises:
checking whether there is a reimbursement content item that does not conform to a preset reimbursement rule in the editable reimbursement form; and
upon determining that there is a reimbursement content item that does not conform to a preset reimbursement rule in the editable reimbursement form, sending corresponding prompt information to a user, to prompt the user to adjust content of the reimbursement content item; and
the performing credibility verification on the editable reimbursement form in at least one verification dimension based on the electronic ticket, the order data, and the bill data comprises:
performing, in at least one verification dimension based on the electronic ticket, the order data, and the bill data, credibility verification on an editable reimbursement form fed back by the user based on the prompt information.

14. The method according to claim 1, further comprising:
upon determining that verification in any verification dimension fails, displaying corresponding prompt information to a user, to prompt the user to process at least one of the editable reimbursement form, the electronic ticket, the order data, and the bill data.

15. (canceled)

16. A ticket processing device, comprising a processor and a memory, wherein the memory stores executable instructions that, in response to execution by the processor, cause the processor to:
obtain a to-be-processed electronic ticket, order data, and bill data, wherein the bill data is generated after a payment is made for the order data by using a reimbursement code, and the electronic ticket is generated based on the bill data;
create an editable reimbursement form based on at least one of the electronic ticket, the order data, and the bill data;
perform credibility verification on the editable reimbursement form in at least one verification dimension based on the electronic ticket, the order data, and the bill data; and
upon determining that verification in each verification dimension succeeds, determine that the editable reimbursement form is a credible reimbursement form.

17. A non-transitory storage medium, comprising instructions stored therein that, when executed by a processor of a computing device, cause the processor to:
obtain a to-be-processed electronic ticket, order data, and bill data, wherein the bill data is generated after a payment is made for the order data by using a reimbursement code, and the electronic ticket is generated based on the bill data;
create an editable reimbursement form based on at least one of the electronic ticket, the order data, and the bill data;
perform credibility verification on the editable reimbursement form in at least one verification dimension based on the electronic ticket, the order data, and the bill data; and
upon determining that verification in each verification dimension succeeds, determine that the editable reimbursement form is a credible reimbursement form.
